(19) United States
(12) Patent Application Publication
(10) Pub. No.: US 2020/0047988 A1
(43) Pub. Date: Feb. 13, 2020

(54) CAPSULE

(71) Applicant: SARONG SOCIETA' PER AZIONI, 42046 REGGIOLO (REGGIO EMILIA) (IT)

(72) Inventors: ANDREA BARTOLI, REGGIO EMILIA (IT); DAVIDE CAPITINI, REGGIO EMILIA (IT)

(21) Appl. No.: 16/608,252

(22) PCT Filed: May 2, 2018
(86) PCT No.: PCT/IB2018/053036

§ 371 Date: Oct. 25, 2019

(30) Foreign Application Priority Data
May 3, 2017 (IT) 102017000047824

(51) Int. Cl. B65D 85/804; A47J 31/40

(52) U.S. Cl. CPC B65D 85/8043; A47J 31/407

(57) ABSTRACT

A capsule (1) for preparing a food product (P) comprises a casing (2) that includes a base wall (3) and a side wall (4) defining a cavity (5) adapted to contain a food preparation (P) and a flange-shaped edge (6) extending from the lateral wall (4), wherein the side wall (4) comprises a zone (4a) which is deformable along predefined pliability lines (21) to allow the casing (2) to be It compressed along a direction (A) parallel to an axis of symmetry (S) of the capsule (1) between an undeformed configuration, a first intermediate deformed configuration and a second final deformed configuration. The capsule (1) further comprises a bottom (20) of the base wall (3), which comprises an opening (7), a cover element (8) fixed to the flange-shaped edge (6) to hermetically close the cavity (5) and a tube (10) fixed to the cover element (8). The tube (10) comprises a first end (11), which is arranged to receive a fluid injecting device for supplying the fluid (F) to the cavity (5) and obtaining a food production from said food preparation (P); a second end (12) through which the food product is dispensed to the outside; a body (14) that extends between said first end (11) and said second end (12) and that can slide in a sealed manner in the opening (7) of the bottom (20); in which the body (14) comprises an inner conduit (16) that extends along said body (14) in the direction of said axis of symmetry (S) and is closed at a first end by an end wall (11a) and communicates at a second end with a dispensing opening (22); the inner conduit (16) can communicate with the cavity (5) of the capsule (1) through at least one transverse conduit (17), which is arranged at a distance (L) from said second end (12) of the tube (10) chosen in such a manner that said at least one transverse conduit (17) is outside the capsule (1) when the capsule (1) is compressed along the pliability lines until a final deformed configuration. A method for dispensing a food preparation (P) contained in the capsule (1) comprises the following steps: compressing the capsule (1) until a first intermediate deformed configuration to cause the detachment of a closing element (23) of a bottom (20) of the capsule (1), introducing pressurised air into the capsule (1) to dispense the food product (P) contained therein and further compressing the capsule (1) until a second final deformed configuration.

The invention relates to capsules or containers, containing a food preparation, to be used in machines for dispensing a food product, and it further relates to a method for using such capsules in an automatic dispensing device.

In more detail, the invention relates to a sealed, single-portion and disposable capsule, containing a food preparation, which may be in liquid form, or in powder, syrup or paste form, said capsule being able to dispense through a pressurised fluid the food preparation, possibly dissolved, or diluted, for subsequent uses.

If the food preparation is in powder form, it may be soluble or freeze-dried or dehydrated. Alternatively, if it is for example a syrup or a cream, it may be a concentrate.

The food preparation, dispensed by the capsule, may for example also optionally be dissolved or diluted with a hot or cold liquid, typically water or milk.

Capsules for beverages usable in dispensing machines are known.

The known capsules are disposable and single-portion containers comprising an outer casing, made of liquid- and gas-proof plastic material and having the shape of a glass or cup. In particular, the casing has a bottom wall and a side wall defining a cavity provided with an upper opening through which a preparation can be inserted from which to obtain a beverage. The upper opening is hermetically closed by a cover, typically a film containing aluminium or a multi-layer plastic film, so as to seal the preparation inside the cavity of the container. The capsule cover can be perforated by an injecting device of the dispensing machine to allow the insertion of a pressurised liquid, typically water, with which to prepare the beverage.

In relation to the dispensing of the beverage obtained, the bottom wall of the casing can also be perforated by an extracting means of the dispensing machine, to allow the dispensing of the beverage.

Alternatively, capsules for beverages are also known, for example described in patent application WO2014102701 by the same applicant, able to dispense the beverage directly into a container for drinking (cup, glass, etc.) without any need for perforation by the extracting means of the dispensing machine.

The known capsules described above allow the beverage to be obtained as a food product through the percolation of liquid through the food preparation (typically coffee) or through solubilisation or dissolving the preparation itself (e.g. tea, herbal teas, etc.) and are distinguished by the interaction of the food preparation contained in the capsule with a liquid inserted therein, to prepare the beverage directly inside the capsule and dispense the beverage thus formed.

Such capsules are however not very suitable for dispensing a viscous food preparation, in syrup or creamy form, or a powder preparation.

Capsules for beverages are also known, as shown, for example, in WO2005077811, which allow a viscous food preparation to be dispensed into a cup, into which hot, or cold, water is also supplied, to dilute the food preparation in the cup itself and thus obtain a beverage. The capsule shown by WO2005077811 comprises a crushable body provided with a cavity, which is closed by a cover fixed to a flanged edge of the capsule, inside which there is a syrup (concentrated coffee, chocolate or fruit syrup) which exits from the cover of the capsule when the capsule is compressed and crushed. In detail, the cover breaks at a sealing portion, allowing the food preparation to be poured into the cup.

The capsules described above are therefore typically associated with specific dispensing machines in which there is a liquid injecting device or a beverage dispensing device appropriately designed to be compatible with a determined type of capsule and not with others. These capsules are usually used in dispensing machines with reduced dimensions and are usually designed for domestic use, and it is the consumer who, at the time of purchase, establishes the machine system and capsule he/she prefers for the envisaged uses.

These capsules could however not be adapted for use in dispensing machines of a food product of another type, made through recipes that require one or more ingredients, as the supply of food preparations with different types of formulations from the capsule may be required.

For example, some recipes may require receiving from the capsule a powder preparation, others could require a syrup preparation, others again could require a preparation already diluted with milk or with water.

WO2013121421 shows an ice-cream machine for obtaining a single-portion ice-cream starting from one or more containers that can be inserted in the machine, containing the necessary ingredients. Various versions of the same machine are envisaged, a first version which is configured to house “dry” containers, in which the preparation contained therein is to be diluted with a liquid and for which a connection to the water network or to a tank of liquid is required (the container to be used has both a cover and a bottom that can be perforated), and a second version which is instead configured to house “wet” containers in which the preparation does not require the insertion of a liquid, as it is already diluted (the container to be used only has a bottom that can be perforated).

The ice cream machine shown by WO2013121421 can also prepare ice cream with combinations of ingredients from two distinct containers, attachable to each other by a joint, e.g. to join a first container containing a preparation for ice cream and a second one containing toppings such as chocolate chips.

WO2013121421 therefore envisages different capsules, in terms of size and contents, for supplying the ice cream machine with a food preparation of different formulation and therefore various versions of the same machine are required, each version specifically envisaged for one type of capsule.

It is to be noted however that the capsule can dispense a food preparation already mixed with water or milk but cannot dispense a pasty food preparation, such as a typical base for ice cream used in artisan ice cream shops, or a powdered food preparation.

An object of the present invention is to propose a sealed, disposable and single-portion capsule able to dispense a food preparation contained therein for subsequent uses.

A further different object is that of obtaining an extremely versatile capsule, able to dispense a food preparation in powder, syrup, diluted or not, and pasty, that can be used in a dispensing device adapted to receive the capsule and make the food preparation contained therein exit, together with a pressurised fluid, to obtain a beverage, or to send the food preparation to a batch freezing unit for preparing a portion of ice cream.

Such objects and yet others are reached by a capsule according to one or more of the claims reported below.

The invention can be better understood and implemented with reference to the appended drawings, which illustrate some non-limiting example embodiments, and in which:

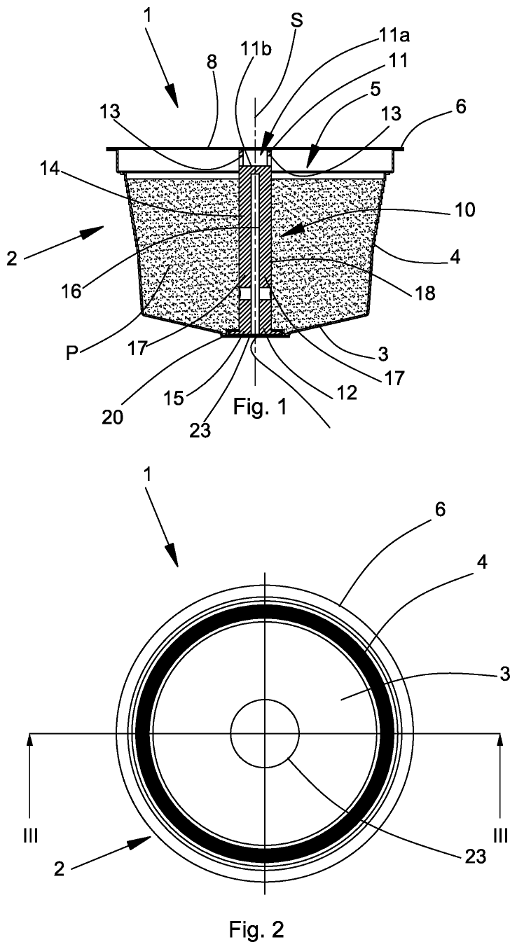

FIG. 1 is a section of a capsule according to the invention containing a food preparation, in a first undeformed configuration, through a plane passing through the line I-I of FIG. 2;

FIG. 2 is a view from the bottom of the capsule of FIG. 1;

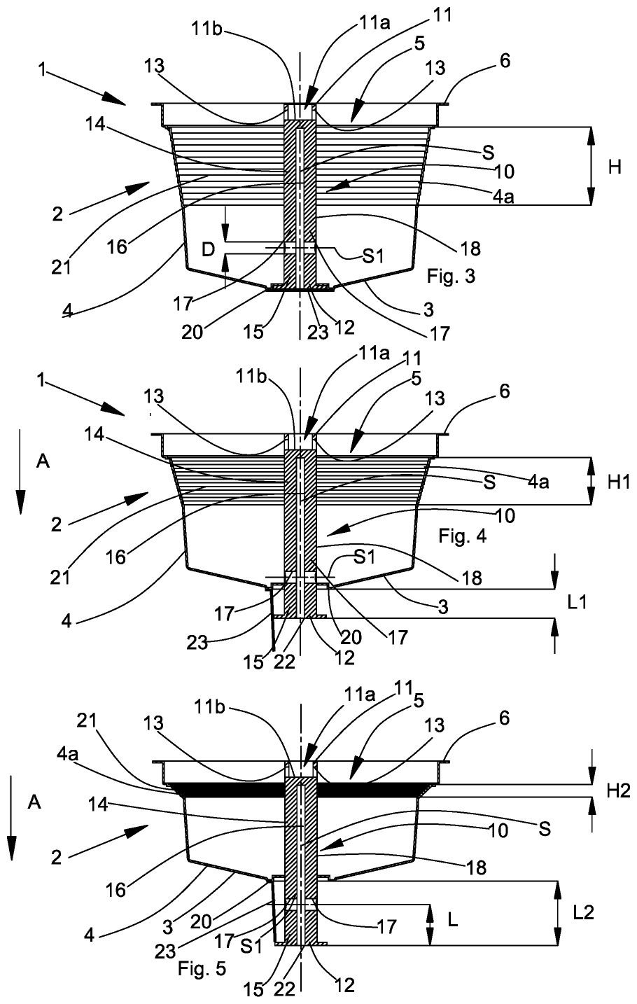

FIG. 3 is a section like the one of FIG. 1 in which the food preparation inside the capsule has been omitted;

FIG. 4 is a view of the capsule of FIG. 1 in a second configuration, deformed, sectioned through a plane passing through an axis of symmetry of the capsule;

FIG. 5 is a view of the capsule of FIG. 1 in a third configuration, deformed, sectioned through a plane passing through an axis of symmetry of the capsule;

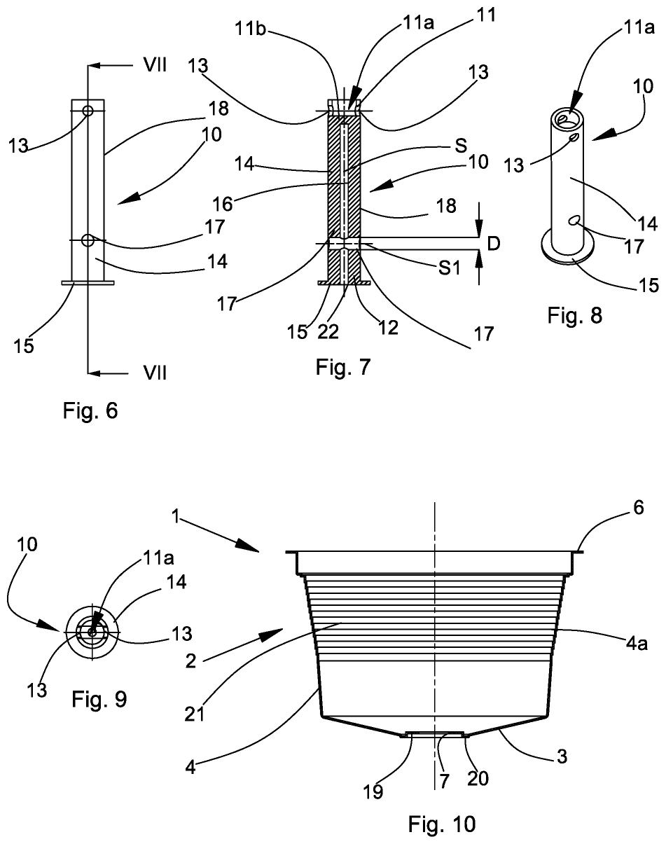

FIG. 6 is an elevated view of a detail of the capsule according to the invention;

FIG. 7 is a section of the detail of FIG. 6, through a plane passing through the line VII-VII of FIG. 6;

FIG. 8 is a perspective view of the detail of FIG. 6;

FIG. 9 is a view from above of the detail of FIG. 6;

FIG. 10 is a section like the one of FIG. 3 in which the detail of FIG. 6 has been omitted;

The same elements will be indicated in the various figures below with the same numbers.

With reference to FIGS. 1 to 10, a capsule 1 according to the invention containing a food preparation P is illustrated, which can be used in an automatic dispensing device for dispensing a food product, obtained from the food preparation P itself, dissolved or diluted, for subsequent uses.

The food preparation P can be, for example, a powdered food product (soluble, freeze-dried, dehydrated, concentrated, for percolating, for infusion) or may be a product in syrup, cream or concentrated paste form). The capsule 1 comprises a casing 2 which includes in turn: a base wall 3, a side wall 4 defining a cavity 5 adapted to contain the food preparation P and a flange-shaped edge 6 extending from the side wall 4, in particular surrounding the cavity 5.

The capsule 1 comprises a bottom 20 of the base wall 3 provided with an opening 7. Preferably, the opening 7 is made in a substantially central position of the base wall.

The side wall 4, further, diverges starting from the base wall 3 up to the edge 6 and has, for example, an almost truncoconical shape so as to confer a glass or cup shape to the casing.

The casing 2 is compressible and/or crushable and is therefore deformable. The casing is made by forming a thermoformable sheet material, in particular a liquid- and gas-proof multilayer plastic material suitable for food contact.

To allow the casing 2 to be compressed and crushed along a direction A almost parallel to a longitudinal axis of symmetry S of the capsule 1 and substantially orthogonal to the bottom 20, the side wall 4 is deformable along predefined pliability lines 21, for example accordion-shaped or bellows-shaped, as will be clearer below. The side wall 4 is, therefore, deformable between an undeformed configuration, a first intermediate deformed configuration and a second final deformed configuration.

The compressible and/or crushable casing 2 allows a volume of the casing to be gradually reduced, reducing the distance between the base wall 3 and the flange-shaped edge 6, during the dispensing of the food product. The capsule 1 further comprises a cover element 8 fixed to the flange-shaped edge 6 to hermetically close the cavity 5.

The cover element 8 is realised with selected materials, for example multilayer plastic polycoupled materials, so as to protect over time the food preparation P contained in the capsule from moisture and oxygen. Such multilayer plastic materials can for example contain aluminium or a different barrier layer, e.g. ethylene vinyl alcohol (EVOH) or polyvinylidene chloride (PVDC), to prevent the inlet of moisture and oxygen into the cavity 5 of the capsule 1, in which the food preparation P is contained.

The capsule 1 further comprises a tube 10 fixed to the cover element 8, which comprises a first end 11 and a second end 12 opposite each other. The first end 11 is arranged for receiving a fluid injecting device (not illustrated) of an automatic dispensing device (not illustrated).

Preferably, the first end 11 of the tube 10 has a respective cavity 11a in which the fluid injecting device of the automatic dispensing device can be engaged. As shown in the appended figures, the cavity 11a of the tube 10 is open at the top to receive the fluid injecting device, is delimited at the bottom by a bottom wall 11b free from openings and is delimited at the side by a side wall 11c on which a plurality of openings 13 is afforded for supplying a fluid to the cavity 5 through the injecting device of the dispensing device.

For example, a side wall 11c of the cavity 11a comprises a pair of diametrically opposite openings 13.

The fluid can, for example, be a pressurised liquid, for example water, with which the food preparation P is diluted and/or dissolved at the time of dispensing, or pressurised air, whose function will be explained in detail below.

The tube 10 comprises a body 14 that extends between the first end 11 and the second end 12 and that can slide in a sealed manner in the opening 7 of the bottom 20.

The body 14 of the tube 10 comprises an inner conduit 16 that extends along said body 14 in the direction of said axis of symmetry S. The conduit 16 is closed at a first end by the end wall 11a and communicates at a second end, at the second end 12 of the tube 10, with a dispensing opening 22, through which a food product obtained from the food preparation P contained in the capsule 1 can be dispensed outside the capsule 1, if necessary after being dissolved or diluted with a liquid inserted into the capsule 1.

The inner conduit 16 has a diameter comprised between 0.3 mm and 3 mm, preferably a diameter comprised between 0.5 mm and 1 mm, i.e. it has reduced dimensions for reasons that will be explained below.

The second end 12 of the tube 10 comprises a flange 15 that peripherally surrounds the second end 12.

The bottom 20 of the base wall 3 comprises a recess 19, which is provided with the opening 7. It is to be noted that, in an initial undeformed configuration of the capsule 1, the flange 15 is housed in the recess 19, and contributes to guaranteeing, together with the body 14 of the tube 10, a hermetic closure of the opening 7 of the base wall 3.

The capsule 1 additionally comprises a closing element 23 fixed at least partially detachably, as will be illustrated better below, to the base wall 3 to hermetically close the opening 7.

Preferably, the recess 19 is hermetically closed by the closing element 23 fixed partially detachably to the bottom 20 of the capsule 1. The closing element 23 is made of plastic material, or aluminium, weldable, for example thermally or through ultrasound to the bottom 20.

The closing element 23, for example, disc-shaped, comprises a joining edge, not illustrated, for example annular, through which it is fixed to the base wall 3.

The closing element may be easily detached from the base wall 3 automatically by the tube 10 itself, in the first intermediate deformed configuration, when the casing 2 is partially crushed.

The closing element 23, provided with or without a gripping tab, made of plastic material, or aluminium, is weldable, for example, thermally or through ultrasound, and the joining edge is in particular fixed to an outer annular portion (not illustrated) of the base wall 3 for a first stretch (not illustrated) through a locking fastening, for example a locking welding, and for a second stretch (not illustrated) through a detachable fastening, for example, a detachable welding, the locking fastening requiring a greater force with respect to the detachable fastening for detaching the joining edge from the base wall 3, so as to promote the detachment of the second joining stretch before the detachment of the first stretch, when the closing element 23 is pushed by the flange 15 to be detached from the base wall 3.

In this way, the closing element 23 is detached from the base wall 3 at the second stretch.

In a different embodiment of the capsule 1 according to the invention, not illustrated, the bottom 20 is flat and does not comprise the recess 19. In the initial undeformed configuration, the flange 15 abuts on the bottom 20 and is therefore interposed between the latter and the closing element 23. The above information regarding the connection of the closing element 23 to the base wall 3 through detachable or locking fastening still remains valid.

The dispensing opening 22 of the tube 10, in the undeformed configuration of the capsule 1, is closed by the closing element 23, which prevents the food preparation P contained in the capsule 1 being able to accidentally exit through the dispensing opening 22 and further prevents air and moisture being able to penetrate from the outside into the cavity 5 of the capsule 1 through the dispensing opening 22.

The tube 10 additionally comprises at least one transverse conduit 17. In detail, the inner conduit 16 communicates with the cavity 5 of the capsule 1 through the transverse conduit 17. The transverse conduit 17 is configured to receive the food product, obtained from the food preparation P, contained in the cavity 5 of the capsule 1 and supplying the food product to the dispensing opening 22 of the tube 10.

For example, the transverse conduit 17 has a diameter D, which extends perpendicularly with respect to the inner conduit 16 and opens onto an outer surface 18 of the tube 10. The at least one transverse conduit 17 preferably comprises a pair of opposing transverse conduits 17.

The at least one transverse conduit 17 is arranged at a distance L from the second end 12 of the tube 10, chosen in such a manner that the at least one transverse conduit 17 is outside the capsule 1 when the capsule 1 is in the second final deformed configuration.

The distance L is measured between an axis S1 of said at least one transverse conduit 17 and the second end 12 of the tube 10, in a parallel direction to the axis of symmetry S.

The side wall 4 of the capsule 1 comprises a zone 4a provided with a group of pliability lines 21 whose function is to allow the casing 2 of the capsule 1 to be compressed along said direction A almost parallel to the axis of symmetry S of the capsule 1. The zone 4a is, for example, contiguous to the flange-shaped edge 6. In other embodiments of the capsule 1, not illustrated, the zone 4a may be contiguous to the base wall 3.

The zone 4a extends for a height H, measured in the parallel direction to the axis of symmetry S of the capsule, when the capsule 1 is in a first undeformed configuration.

Thanks to the pliability lines 21, the capsule 1 may be compressed by passing from the first undeformed configuration, visible in FIGS. 1, 3 and 10, to the first intermediate deformed configuration, visible in FIG. 4, in which the zone 4a extends for a height H1<H. In this first intermediate deformed configuration, the tube 10 projects from the bottom 20 for a distance L1=H−H1. The distance L1 is less than the distance L.

Advantageously, the distance L at which the transverse conduit 17 is arranged is chosen so that the at least one transverse conduit 17 is inside the capsule 1, i.e. in the cavity 5, when the capsule 1 is in the first intermediate deformed configuration. In particular, the at least one transverse conduit 17, in such first intermediate deformed configuration, is substantially tangent to the recess 19.

In particular, so that the at least one transverse conduit 17 remains inside the capsule 1 in the first intermediate deformed configuration, the distance L1 must be less than L-D/2.

The capsule 1 may be further compressed by passing from said first intermediate deformed configuration and a second final deformed configuration, visible in FIG. 5, in which the zone 4a extends for a height H2<H1. In this second final deformed configuration, the tube 10 projects from the bottom 20 of the capsule 1 for a distance L2=H−H2, so that the at least one transverse conduit 17 is outside the capsule 1. In particular, so that the at least one transverse conduit 17 can be outside the capsule 1, the distance L2 must be greater than L+D/2.

In use, if the food preparation P contained in the capsule 1 is in liquid form and does not need to be diluted, to dispense the food product, obtained from the food preparation P, from the capsule 1, the process is as follows: first of all there is a first compression of the capsule 1 along the direction A almost parallel to the axis of symmetry S of the capsule 1, bringing the capsule into the first intermediate deformed configuration. During the compression of the capsule, the tube 10 slides in the opening 7 exiting from the bottom 20 of the capsule 1 and causing with its flange 15 the partial detachment of the closing element 23 from the bottom 20 of the capsule 1, freeing the dispensing opening 22, as can be seen in FIG. 4.

Subsequently, pressurised air is introduced into the capsule 1, through a fluid injecting device that perforates the cover element 8 and is inserted in the further cavity 11a of the tube 10. In this case, the food product dispensed from the capsule is obtained from the food preparation P only because the food preparation P is mixed with air, being pushed by the air itself.

Preferably, the air introduced is at a pressure comprised between 0.2 and 2 Bar.

The pressurised air introduced into the capsule 1 pushes the food preparation P into the at least one transverse conduit 17 and from there into the inner conduit 16 of the tube 10 and to the dispensing opening 22 through which the food preparation P is dispensed to the outside, for example into a container or into the batch freezing unit of an ice cream machine. In order to be able to dispense the food preparation P contained in the capsule 1 in a substantially complete way, it is necessary that, in said intermediate deformed configuration, the at least one transverse conduit 17 is substantially tangent to the bottom 20, in particular to the recess 19 of the bottom 20, as can be seen in FIG. 4.

At the end of the dispensing of the food preparation P, the introduction of pressurised air into the capsule 1 is extended for a sufficient amount of time to guarantee the cleaning of the inner conduit 16 and of the dispensing opening 22 from any residues of food preparation P, to prevent any dripping of the food preparation P occurring when the capsule is removed.

By inserting pressurised air, at a pressure comprised between 0.2 and 2 Bar, the cleaning of the inner conduit 16 is performed efficiently. Additionally, thanks to the reduced dimension of the inner conduit 16, comprised in an interval between 0.3 mm and 3 mm, any minimum part of liquid still present in the inner conduit 16 does not exit from the inner conduit 16 itself.

Once the dispensing of the food preparation P and the cleaning of the inner conduit 16 and of the dispensing opening 22 are complete, the capsule 1 is further compressed until the second final deformed configuration illustrated in FIG. 5, in which the at least one transverse conduit 17 is brought outside the capsule 1. This prevents any residual food preparation P still inside the capsule at the end of the dispensing being able to drip outside, when the capsule is extracted from the dispensing machine and brought to a disposal site.

The dripping is prevented thanks to the fact that the tube 10 is hermetically coupled in the opening 7 of the base wall 3 and the fact that any residual food preparation P present inside the capsule 1 cannot reach into the inner conduit 16 of the tube 10 and the dispensing opening 22, because the at least one transverse conduit 17 that allows access to the inner conduit 16, is outside the capsule 1 and is therefore not accessible for any residual food preparation P that is inside the capsule.

Advantageously, as previously mentioned, dripping is also prevented thanks to the reduced dimensions of the inner conduit 16.

If at the end of the opening stroke of the closing element 23 the transverse conduit 17 is immersed in the food preparation P, it can start to exit by compression until reaching a tangent position to the bottom 20, after which the complete emptying of the container takes place by the introduction of pressurised air through the fluid injecting device which perforates the cover element 8 and is inserted in the further cavity 11a of the tube 10.

If the first compression step does not bring the transverse conduit 17 into the tangent position to the bottom 20 then it is necessary to further compress the container to make more food product exit by compression and simultaneously inject pressurised air to increase the exit speed of the food preparation P.

If the food preparation P contained in the capsule 1 is in soluble powder, or syrup, or paste form, which must be dissolved or diluted before dispensing such as, for example, in the case of a base for ice creams, after the compression step previously described, first of all a pressurised liquid, for example water, or milk, is inserted into the capsule 1, to dissolve, or dilute, the food preparation P and obtain the food product.

The liquid is inserted into the capsule through an injecting device of a dispensing machine, which is adapted to perforate the cover element 8 and be inserted in the cavity 11a of the tube 10.

The pressurised liquid dispensed by the injecting device enters the cavity 5 of the capsule 1 through the openings 13 made in the side wall 11c of the further cavity 11a and dissolves, or dilutes, the food preparation P, obtaining the food product, which starts to be dispensed by the capsule 1 passing through the at least one transverse conduit 17, the inner conduit 16 and the dispensing opening 22 of the capsule 10. Through the transverse conduit 17, the food product is supplied to the dispensing opening 22.

Subsequently, pressurised air is introduced into the capsule 1, still through the aforementioned injecting device, to complete the dispensing of the food preparation P and clean the inner conduit 16 and the dispensing opening 22.

Finally, the capsule 1 is further compressed until the second final deformed configuration illustrated in FIG. 5, in which, as already mentioned, the at least one transverse conduit 17 is brought outside the capsule 1 to prevent any food preparation P, or residual food product, still inside the capsule at the end of the dispensing, being able to drip outside when the capsule is extracted from the dispensing machine and taken to a disposal site.

It is also possible to define a method for dispensing a food preparation P in liquid form, in an automatic dispensing device through the capsule 1 according to the invention, comprising the following steps:
a first partial crushing step of the capsule 1 in which a zone 4a of the side wall 4 of the casing 2 of the capsule 1 is deformed along the pliability lines 21, in particular compressing the capsule 1 along a direction A substantially parallel to an axis of symmetry S of the capsule 1 to make the capsule pass from an undeformed configuration to a first intermediate deformed configuration in which the at least one transverse conduit 17 is substantially tangent to the recess 19 of the bottom 20 of the capsule 1, during said first crushing step the tube 10 sliding in said opening 7 causes the partial detachment of the closing element 23, so as to free the dispensing opening 22;
an injection step in which compressed air is inserted into the capsule 1 through a fluid injecting device, for dispensing a food product from the capsule 1, obtained by mixing the food preparation P with air, and cleaning the inner conduit 16 and the dispensing opening 23 of the tube 10;
a second crushing step in which the capsule 1 is further deformed along said pliability lines 21, compressing it in said direction A until making it pass from said first intermediate deformed configuration to a second final deformed configuration in which the tube 10 projects from the bottom 20 of the capsule 1 for a distance L2 chosen so that the at least one transverse conduit 17 is outside the capsule 1.

According to a variant of the method according to the invention, particularly adapted for the dispensing of a food preparation P which needs to be diluted, i.e. a food preparation in powder, syrup or paste form, after the first crushing step and before the step of inserting compressed air into the capsule 1, a step is provided of inserting pressurised liquid into the capsule 1, for diluting the food preparation P and starting to dispense the food product obtained from the food preparation P, the dispensing of the food preparation P, being completed in the subsequent step of inserting compressed air into the capsule 1.

Thanks to the capsule 1 according to the invention, it is possible to dispense the food preparation P contained therein for subsequent uses, regardless of the type of food preparation P contained therein, in liquid form, powder, syrup or paste form.

The capsule 1 according to the invention can be used for preparing a beverage, starting from the food preparation P, or for supplying the food preparation P to an ice cream machine and, advantageously, pressurised air can be used not only for performing or completing the emptying of the capsule 1, but also for cleaning, at the end of the dispensing of the food preparation P, the inner conduit 16 and the dispensing opening 22 of the tube 10 to prevent any dripping of the food preparation P, or of the food product obtained therefrom, occurring when the capsule is removed from the dispensing machine.

The capsule 1 according to the invention further has the advantage that any residual food preparation P, or food product contained therefrom, still in the capsule at the end of the dispensing cannot drip outside while the capsule is extracted from the dispensing machine and while it is sent to a disposal site. This is thanks to the fact that in the second deformed configuration of the capsule according to the invention there is no communication between the inside of the capsule and the dispensing opening 22.

1. A capsule, comprising:
a casing (2) that includes:
a base wall (3) and a side wall (4) defining a cavity (5) that is adapted to contain a food preparation (P);
a flange-shaped edge (6) extending from the side wall (4);
in which the side wall (4) comprises a zone (4a) that is deformable along predefined pliability lines (21) to enable the casing (2) to be compressed along a direction (A) parallel to an axis of symmetry (S) of the capsule (1) between an undeformed configuration, a first intermediate deformed configuration and a second final deformed configuration; and
in which a bottom (20) of the base wall (3) comprises an opening (7);
in which the capsule (1) further comprises:
a cover element (8) fixed to the flange-shaped edge (6) to hermetically close the cavity (5);
a closing element (23) fixed at least partially detachably to the base wall (3) to hermetically close said opening (7);
a tube (10) fixed to the cover element (8), in which the tube (10) comprises:
a first end (11) arranged for receiving a fluid injecting device for supplying the fluid (F) to the cavity (5) and obtaining a food product from said food preparation (P);
a second end (12) through which the food product is dispensed outside;
a body (14) that extends between said first end (11) and said second end (12) and can slide in a sealed manner in said opening (7) of said bottom (20);
in which said body (14) comprises an inner conduit (16) that extends along said body (14) in the direction of said axis of symmetry (S), said conduit (16) being closed at a first end by an end wall (11a) and communicating at a second end, at the second end (12) of the tube (10), with a dispensing opening (22);
in which said inner conduit (16) can communicate with the cavity (5) of the capsule (1) through at least one transverse conduit (17) for supplying the food product of the cavity (5) to the dispensing opening (22),
characterised in that said at least one transverse conduit (17) is arranged at a distance (L) from said second end (12) of the tube (10) chosen in such a manner that said at least one transverse conduit (17) is outside the capsule (1) when the capsule (1) is in said second final deformed configuration.

2. The capsule according to claim 1, wherein said distance (L) is chosen in such a manner that said at least one transverse conduit (17) is inside the capsule (1) and is substantially tangent to said recess (19) when the capsule (1) is in said first intermediate deformed configuration.

3. The capsule (1) according to claim 1, wherein said distance (L) is measured between an axis (S1) of said at least one transverse conduit (17) and the second end (12) of the tube (10), in a direction parallel to the axis of symmetry (S).

4. The capsule (1) according to claim 1, wherein said zone (4a) extends for a height (H) measured in a direction parallel to the axis of symmetry (S), when the capsule (1) is in said undeformed configuration.

5. The capsule (1) according to claim 1, wherein said zone (4a) extends for a height (H1) measured in a direction parallel to the axis of symmetry (S), when the capsule (1) is in said first intermediate deformed configuration, H1 being <H.

6. The capsule (1) according to claim 1, wherein said zone (4a) extends for a height (H2) measured in a direction parallel to the axis of symmetry (S), when the capsule (1) is in said second final deformed configuration, H2 being <H1.

7. The capsule (1) according to claim 5, wherein, when the capsule (1) is in said first intermediate deformed configuration, said tube (10) protrudes from said bottom (20) of the capsule (1) for a distance L1=H−H1, in which L1<L−D/2, D being the diameter of said at least one transverse conduit.

8. The capsule (1) according to claim 6, wherein, when the capsule (1) is in said second final deformed configuration said tube (10) protrudes from a bottom (20) of the capsule (1) for a distance L2=H−H2, in which L2>L+D/2, D being the diameter of said at least one transverse conduit.

9. The capsule according to claim 1 wherein the bottom (20) of the base wall (3) comprises a recess (19) provided with the opening (7) and wherein the second end (12) of the tube (10) comprises a flange (15) that surrounds said second end (12), said flange (15) being housed in said recess (19) in said undeformed configuration.

10. The capsule (1) according to claim 1, wherein the zone (4a) is contiguous to said edge (4).

11. A method for dispensing a food preparation P in an automatic dispensing device by a capsule (1) according to claim 1, comprising the following steps:
a first partial crushing step of the capsule (1) in which a zone (4a) of a side wall (4) of a casing (2) of the capsule (1) is deformed along pliability lines (21), in particular compressing the capsule (1) along a direction A, that is substantially parallel to an axis of symmetry (S) of the capsule (1), so as to make the capsule (1) pass from an undeformed configuration to a first intermediate deformed configuration so as to slide a tube (10) of the capsule (1) through an opening (7) made in a bottom (20) of the capsule (1) so that a flange (15) of the tube (10) causes the partial detachment of a closing element (23) of said bottom (20);
an injecting step in which pressurised air is delivered to the capsule (1) using injecting means of an automatic dispensing device in a cavity (11a) of the tube (10), that communicates through openings (13) with a cavity (5) of the capsule (1) containing said food preparation (P), said pressurised air pushing the food preparation (P) within at least one transverse conduit (17) of the tube (10) that communicates with an inner conduit (16) of the tube (10) terminating with a dispensing opening (23) through which the food preparation (P) is delivered outside the capsule (1);
a step of cleaning said inner conduit (16) and said dispensing opening (23) by said pressurised air, at the end of dispensing said food preparation (P);
a second crushing step in which the capsule (1) is further deformed along said pliability lines (21), compressing it in said direction (A) until the capsule (1) is passed from said first intermediate deformed configuration to a second final deformed configuration.

12. The method according to claim 11, further comprising, after said first crushing step and before said step of delivering pressurised air, a step of delivering pressurised liquid to said cavity (5).

13. The method according to claim 11, wherein at the end of said second crushing step said tube (10) protrudes from the bottom (20) of the capsule (1) for a distance (L2) chosen in such a manner that said at least one transverse conduit (17) is outside the capsule (1).

14. Method according to any claim 11, wherein at the end of said first crushing step said tube (10) protrudes from the bottom (20) of the capsule (1) for a distance (L1) chosen in such a manner that said at least one transverse conduit (17) is inside said cavity (5) of the capsule (1) and is substantially tangent to the bottom (20) of the capsule (1).
